(19) United States
(12) Patent Application Publication
(10) Pub. No.: US 2025/0187480 A1
(43) Pub. Date: Jun. 12, 2025

(54) Pilot Interceptor for Electric Vehicle Supply Equipment

(71) Applicant: Green Bridge Corporation, Raleigh, NC (US)

(72) Inventors: Rick WARGO, Blue Bell, PA (US); Nathan Putnam, Bronx, NY (US)

(21) Appl. No.: 18/974,734

(22) Filed: Dec. 9, 2024

Related U.S. Application Data
(60) Provisional application No. 63/608,053, filed on Dec. 8, 2023.
(60) Provisional application No. 63/729,683, filed on Dec. 9, 2024.

(51) Int. Cl. B60L 53/66; B60L 53/14

(52) U.S. Cl. CPC B60L 53/66; B60L 53/14

(57) ABSTRACT

A pilot interceptor module is disposed in series with a pilot conductor of an EVSE installation. This allows the pilot interceptor module to control operation of the EVSE installation, notwithstanding the use by the EVSE equipment of proprietary and otherwise inaccessible control software.

### CROSS-REFERENCE TO RELATED APPLICATIONS

The present application claims the benefit of U.S. provisional patent application Ser. No. 63/608,053 filed on Dec. 8, 2023 and titled Pilot Interceptor for Electric Vehicle Supply Equipment, and claims the benefit of U.S. provisional patent application Ser. No. 63/729,683 filed on Dec. 9, 2024 and titled Pilot Interceptor for Electric Vehicle Supply Equipment, the disclosures of which are incorporated herein by reference in their entirety.

### FIELD OF THE INVENTION

The present invention relates to electrically motivated transportation equipment, and more particularly, to improvements to Electric Vehicle Supply Equipment.

### SUMMARY

Advances in technology and the imperatives of climate change have motivated a rapid expansion in the market for electric vehicles (EV's). This expansion has been constrained by the need to provide infrastructure for EV charging. In addition to EV charging facilities, the load that those facilities place on conventional generation and transmission infrastructure is significant, as are the costs related to energy use for EV charging.

These costs can be managed through, for example load leveling and other energy management techniques. However, a diversity of Electric Vehicle Service Equipment (EVSE) manufacturers, each employing closed and proprietary internal control software, has impeded the implementation of beneficial energy management procedures.

Standardization of the charging interface, including the availability of a pilot signal, offers an opportunity to overcome this problem. In particular, the present invention provides a mechanism for implementing energy management by intercepting and modifying signals present on the pilot signal conductor.

The EVSE's analog Control Pilot signal is generated by the EVSE to detect the presence of the electric vehicle, to communicate the maximum allowable charging current, and to control charging session begin/end; the electric vehicle then uses that information to decide how much of the EVSE's available peak output capacity the EV can pull based on the vehicle battery's current operating parameters at that moment (e.g. state of charge, temperature, etc.)

There are also digital-based communication protocols for exchanging data between the EV and EVSE that also utilize the same electrical conductor as the analog Control Pilot signal. According to certain embodiments of the invention, the Pilot Interceptor can read and write data using these additional digital-based protocols.

Managing EVSE charge and discharge rates is very important to the operation of an EVSE. For example, intelligently managing an EVSE's charge rate can prevent expensive utility grid demand charges. Also, intelligently managing an EVSE's discharge rate to send energy bidirectionally back to the grid can provide the electric grid with valuable ancillary services.

EVSEs are typically operated via proprietary—and unregulated—software/firmware that doesn't allow for charge limits to be dynamically implemented. There is no standardized way to manage EVSE charge/discharge limits.

Also, EVSEs are typically operated via proprietary—and unregulated—software/firmware that doesn't allow for the EVSE to interface with ISO/RTO grid signals to manage charge/discharge limits and signal latency for V2G-enabled ancillary services and demand response.

All of these problems are being compounded as more makes/models of EVSEs are deployed into operation on the grid (to charge electric vehicles) that run disparate controlling software/firmware programs.

Accordingly, in its various aspects and embodiments, the Pilot Interceptor solves the above-described problems by bypassing the multitude of existing software/firmware version(s) to create a common means of manipulating an EVSE's pilot signal in a remote-controlled, dynamic, and nearly instantaneous way. The Pilot Interceptor democratizes the control of disparate EVSEs to help EVSE operators avoid high demand charges and prevent grid instability and respond more quickly to ISO/RTO grid signals. The Pilot Interceptor can provide EVSE operators with a common, direct, remote-controlled way to manage their owned infrastructure.

The Pilot Interceptor improves EVSE operation for EVSE operators—most of whom have purchased and own EVSEs, but who cannot control them in a common way—by allowing operators to, a) change EVSE charge rate (i.e., power to EV), b) change the EVSE discharge rate (i.e., power back to grid), c) start/stop EVSE charging sessions, d) start/stop EVSE discharging. All of these functions offer significant opportunity for EVSE operators to control energy costs and maximize revenue through utility grid services.

In its various aspects and embodiments, the Pilot Interceptor, a) allows for faster EVSE control, b) de-risks EVSE control by eliminating/bypassing extra software/firmware layers, c) is a more robust way to manipulate EVSE charge and discharge rates of EV batteries, and d) allows for ISO grid signals to control the EVSE.

In certain embodiments, the Pilot Interceptor is a device that is hardwired inside the EVSE enclosure, intercepting the Pilot Signal before it travels out of the EVSE through the cable that is connected to the EV. This marks an improvement over any system including two “couplers” that attach on one side to the EVSE and on the other to the EV. The Pilot Interceptor only interacts with the electrical conductor associated with the Pilot Signal. Finally, the Pilot Interceptor is able to read and write data using both analog and digital protocols.

The Pilot Interceptor offers the benefits of being simple, small and inexpensive, while enabling remote control of the EV charge/discharge behavior. The Pilot Interceptor is invisible to EV drivers and is thus unsusceptible to tampering or theft. Additionally, since high/dangerous charge/discharge power does not travel through the device, an exemplary Pilot Interceptor requires no consumer safety protocols or certifications to operate legally and safely inside an EVSE. Finally, since the Pilot Interceptor does not interact with any high-power conductors within an EVSE, the Pilot Interceptor can easily be implemented into EVSEs with different EVSE ports/connectors/cables that charge/discharge vehicles using AC or DC power, such as CCS, CHAdeMO, NACS or J1772 EVSE ports.

The following description is provided to enable any person skilled in the art to make and use the disclosed inventions and sets forth the best modes presently contemplated by the inventors of carrying out their inventions. In the following description, for purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the substance disclosed. These and other advantages and features of the invention will be more readily understood in relation to the following detailed description of the invention, which is provided in conjunction with the accompanying drawings.

It should be noted that, while the various figures show respective aspects of the invention, no one figure is intended to show the entire invention. Rather, the figures together illustrate the invention in its various aspects and principles. As such, it should not be presumed that any particular figure is exclusively related to a discrete aspect or species of the invention. To the contrary, one of skill in the art would appreciate that the figures taken together reflect various embodiments exemplifying the invention.

Correspondingly, referenced throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

### BRIEF DESCRIPTION OF THE DRAWINGS

FIG. 1 shows, in cutaway perspective view, a typical EVSE installation;

FIG. 2A shows, in cutaway schematic perspective view, an exemplary EVSE installation including a pilot interceptor according to principles of the invention;

FIG. 2B shows, in cutaway schematic perspective view, additional features of an exemplary EVSE installation including a pilot interceptor according to principles of the invention;

FIG. 3A shows, in schematic block diagram form, an exemplary EVSE installation including a pilot interceptor according to principles of the invention;

FIG. 3B shows, in schematic block diagram form, additional features of an exemplary EVSE installation including a pilot interceptor according to principles of the invention;

FIG. 4 shows, in electrical schematic form, an exemplary pilot interceptor circuit according to principles of the invention;

FIG. 5A shows, in schematic perspective view, an exemplary housing for a pilot interceptor module according to principles of the invention;

FIG. 5B shows, in schematic perspective view, an exemplary mechanical assembly for a pilot interceptor module according to principles of the invention;

FIG. 6 shows, in flowchart form, certain aspects of dedicated control software for a pilot interceptor according to principles of the invention;

FIG. 7 shows, in schematic block diagram form, apparatus exemplary of the invention in an electric vehicle charging environment; and

FIG. 8 shows, in schematic block diagram form, exemplary aspects of a pilot interceptor apparatus prepared according to principles of the invention.

### DETAILED DESCRIPTION

As used in the specification and claims, the singular forms “a”, “an”, and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

The components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the present invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the present invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

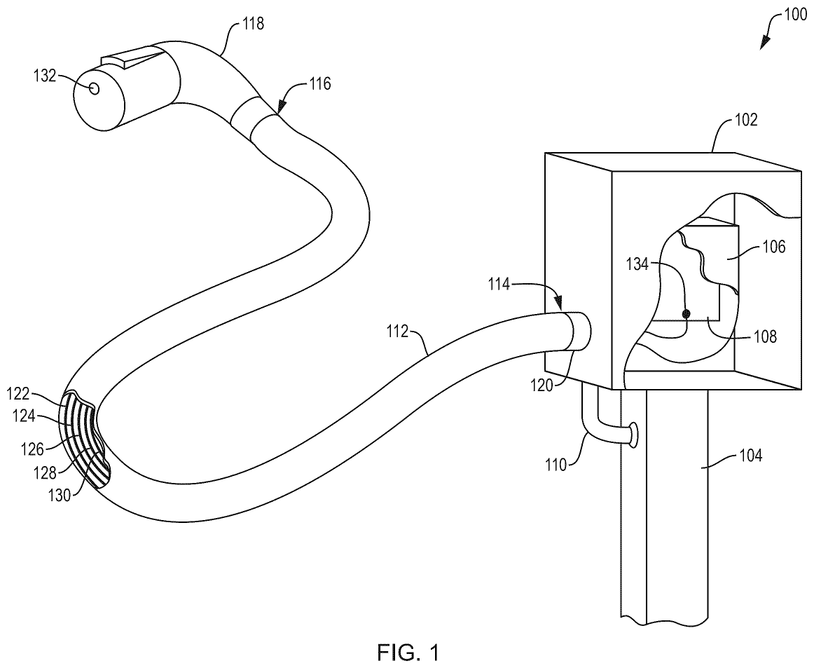

FIG. 1 shows, in cutaway perspective view, a typical EVSE installation 100, including a housing 102 mounted on a support column 104. Housing 102 contains a charging unit 106. The charging unit 106 includes a control circuit 108. An input power cable 110 provides power to the control circuit 108.

A charging cable 112 is connected at a first end thereof 114 to the control circuit 108, and at a second end 116 to a coupler 118. The illustrated coupler 118 is shown, for exemplary purposes, as a standard SAE J1772™ coupler. Between the two ends 114, 116, the charging cable 112 passes through a liquid-tight gland 120 of the housing 102.

The charging cable 112 includes, for example, first 122 and second 124 power conductors along with a safety ground conductor 126. Also included within cable 112 are a pilot signal conductor 128 and a proximity signal conductor 130. In a typical installation, the pilot signal conductor is a continuous wire having a first end connected to a terminal, such as a receptacle pin terminal 132, within the coupler 118 and a second end to a terminal, such as connection point 134 of control circuit 108.

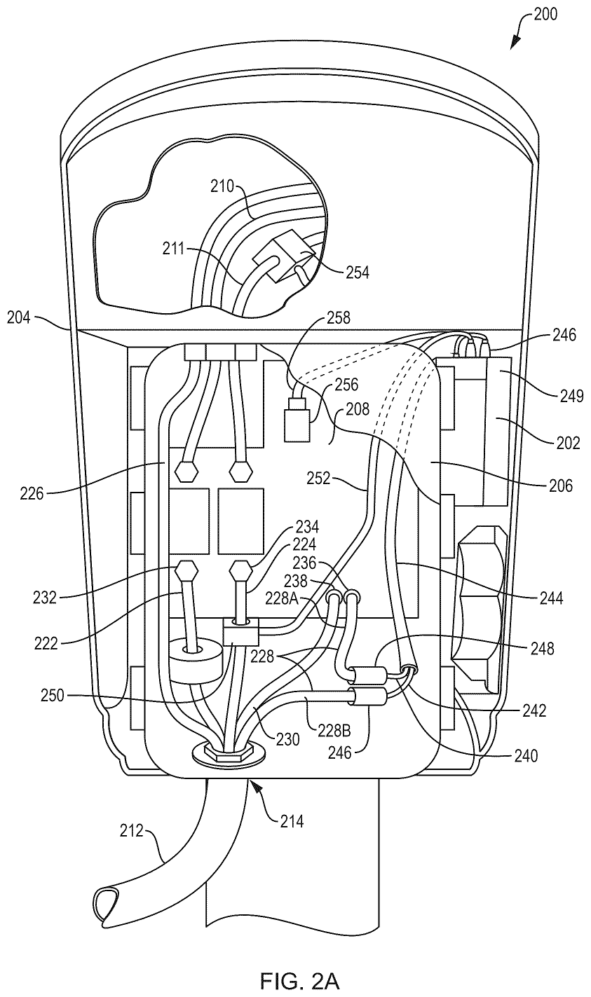

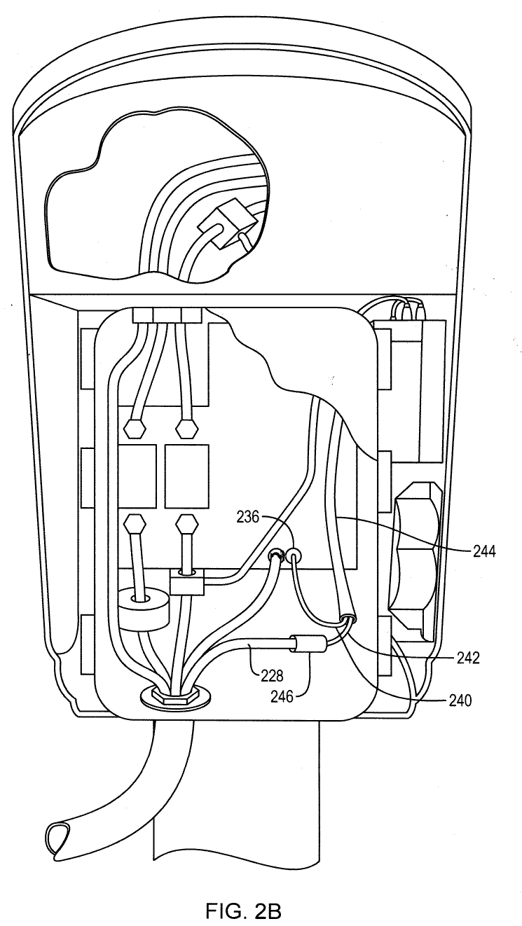

FIG. 2A shows, in cutaway perspective view, an EVSE installation 200 including a pilot interceptor module 202 prepared according to principles of the invention. EVSE installation 200 includes a housing 204 mounted on a support column. Housing 204 contains a charging unit 206. Notably, pilot interceptor module 202 is small enough to fit within housing 204 along with charging unit 206. Placement of the pilot interceptor module 202 within housing 204 tends to secure it from tampering, theft, and/or damage. In addition, because the pilot interceptor 202 fits within housing 204, it does not diminish the aesthetic value of the existing equipment.

The charging unit 206 includes a control circuit 208. Input power conductors 210, 211 provide power to the control circuit 208. A charging cable 212 is connected at a proximal end 214 to the charging unit 206.

The charging cable 212 includes, for example, first 222 and second 224 power conductors along with a safety ground conductor 226. Also included within charging cable 212 are a pilot signal conductor 228 and a proximity signal conductor 230.

As illustrated, power conductors 222 and 224 are substantially permanently connected to respective power output terminals 232 and 234 of control circuit 208. Similarly, the pilot signal conductor 228 and proximity signal conductor 230 are substantially permanently coupled at respective distal ends thereof to respective terminals 236 and 238 of control circuit 208.

According to one exemplary method of the invention, during installation of the pilot interceptor module 202, the pilot signal conductor 228 is severed to form respective portions 228A and 228B. The severed ends are stripped of insulation, and substantially permanently connected to respective pilot signal interceptor conductors 240, 242 of a pilot interceptor cable 244.

In the illustrated embodiment, the respective connections between portion 228A and conductor 240, and portion 228B and conductor 242 are effected with conventional crimp-on connectors, e.g., 246 and 248. In this way, the pilot interceptor cable 244 is placed in series with portions 228A and 228B and secured in substantially permanent fashion.

Although crimp on connectors 246, 248 are shown, one of skill in the art will appreciate that the desirable connection of pilot signal conductor 228 and pilot interceptor cable 244 will be made in any of a variety of ways that are known or become known in the art.

FIG. 2B shows a further embodiment of the invention, including a method in which conductor 240 of pilot interceptor cable 244 is directly permanently coupled to terminal 236 of circuit 208 and pilot interceptor signal conductor 242 is directly coupled to a proximal terminal end of pilot signal conductor 228 as, for example, by a corresponding crimp-on connector 246.

As will be appreciated by one of skill in the art, this method of installation will avoid the need to sever, and strip resulting ends of, pilot signal conductor 228. It will also reduce reliance on the use of crimp on connectors such as connectors 246, 248. Again, it will be appreciated by one of skill in the art that a wide variety of connection methods will be applied in respective embodiments and applications of the invention.

Referring again to FIG. 2A, pilot interceptor cable 244 is coupled at a proximal end thereof 246 to a housing 249 of pilot interceptor module 202. As will be further discussed herewith, respective pilot interceptor conductors 240 and 242 are signalingly coupled to circuitry of the pilot interceptor module 202.

FIG. 2A also shows an exemplary current transformer 250 of the pilot interceptor module 202. A current transformer cable 252 is operatively coupled between current transformer 250 and housing 249 of the pilot interceptor module 202. In the illustrated embodiment, current transformer 250 is disposed about power conductor 224 of charging cable 212.

One of skill in the art will appreciate that the illustrated location of current transformer 250 is only exemplary of a plurality of possible locations where current transformer 250 would be operative to sense charging current for feedback to the pilot interceptor module 202.

Accordingly, transformer 250 could be disposed about conductor 222 of charging cable 212. Alternately, the current transformer could be disposed about either of the input power conductors 210, 211. Thus alternative current transformer 254 is shown, for example, disposed about conductor 211.

One of skill in the art will also appreciate that, in a robust system, a plurality of current transformers, e.g., 250, 254 will be employed for redundancy. In addition, it will be appreciated by one of skill in the art that current transformer 250 is only exemplary of a variety of possible current sensing devices (e.g., a Hall effect sensor device) such as are known or may become known in the art, and which will be beneficially employed in respective embodiments of the invention consistent with the further descriptions of structure and operation provided herewith.

In the illustrated embodiment of FIG. 2A control circuit 208 includes a USB receptacle 256. A USB compatible cable 258 is operatively coupled between the USB receptacle 256 and the pilot interceptor module 202 and serves to provide power to the pilot interceptor module 202 for its operation.

One of skill in the art will appreciate, that power for operation of the pilot interceptor module 202 will be derived from any of a variety of sources, within the housing 204 or otherwise. Thus, for example, in alternative embodiments, the pilot interceptor module could be powered by a dedicated transformer connected to the input power cables 210, 211; by a dedicated battery; by recharging power supplied by a connected vehicle; or in any other way deemed beneficial in a particular application of the invention.

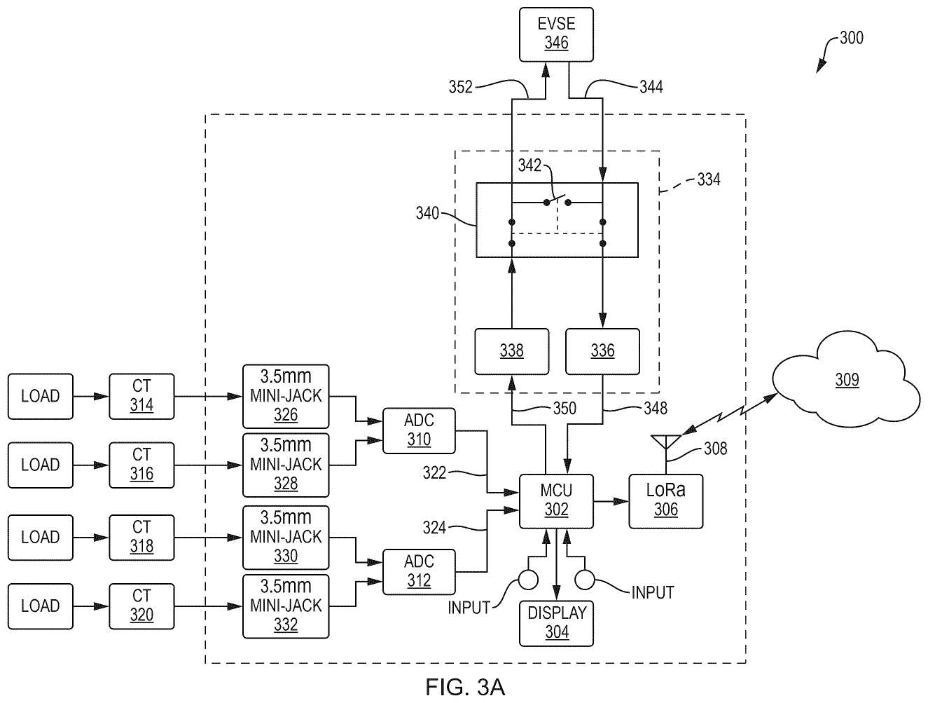

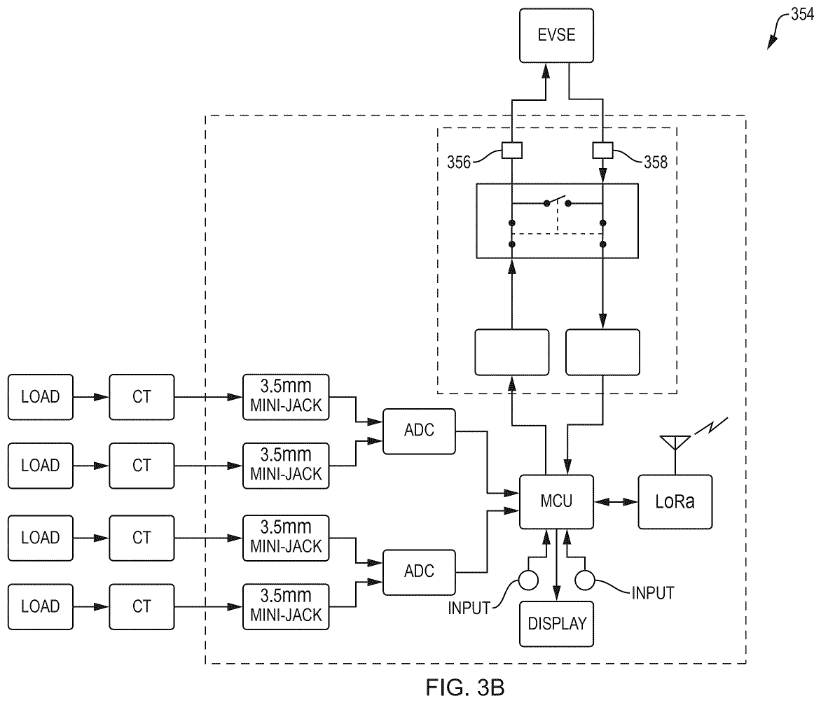

FIG. 3A shows, in schematic block diagram form, a pilot interceptor module 300 prepared according to principles of the invention. The illustrated pilot interceptor module 300 includes an exemplary integrated control unit including a microcontroller 302 and an integrated display 304.

Also included in exemplary microcontroller 302 is an integrated LoRa wireless communication subsystem 306. LoRa subsystem 306 provides a bidirectional wireless network connection between the microcontroller 302 and an external network, such as cloud 309.

In certain applications, an appropriate antenna 308 will be coupled to the LoRa subsystem 306 to permit effective transmission of wireless signals to and from the Cloud 309 (i.e., the Internet, other EVSE installations or other communication network(s)). Connectivity to the cloud 309 permits a variety of benefits including providing an opportunity to take control of an EVSE, as well as modifying a network under which it is controlled, without having access to proprietary internal software of the EVSE. In this way, for example, orphaned EVSE installations can be reactivated and/or returned to service with effective load management.

In the illustrated example of a system according to the invention, first 310 and second 312 analog-to-digital converters are provided to receive, for example, analog feedback signals from respective current transformers 314, 316, 318, 320 and provide corresponding digital signals 322, 324 to the microcontroller 302.

One of skill in the art will appreciate that current transformers 314, 316, 318 and 320 will, in certain embodiments of the invention, be signalingly coupled to respective input and/or output power conductors in the manner of, e.g., current transformers 250 and 254 above. As discussed above, current transformers 314, 316, 318 and 320 are merely representative examples of any appropriate sensor such as, for example, a Hall effect sensor, or other sensor beneficially applied in a corresponding embodiment of the invention.

In the exemplary embodiment of FIG. 3A the current transformers 314, 316, 318 and 320 are coupled to the analog-to-digital converters 310, 312 through respective 3.5 millimeter minijack sets 326, 328, 330, 332, where each minijack set includes a respective male portion and female portion. One of skill in the art will understand that a wide variety of other coupling mechanisms will be used in corresponding embodiments of the invention.

The exemplary pilot interceptor module 300 of FIG. 3A is implemented with a pilot signal processing subsystem 334. In the illustrated embodiment, pilot signal processing subsystem 334 includes an input signal processing module 336, an output signal processing module 338, and an optional bypass switching module 340. One of skill in the art will understand, however, that the particular configuration of components suggested herewith is merely exemplary of a variety of different components and arrangements employed in respective embodiments of the invention.

For example, in certain embodiments of the invention, signal processing modules 336 and 338 will be disposed outwardly of switching module 340. In certain embodiments of the invention, the two signal processing modules 336 and 338 will be configured as a single bidirectional signal processing device or circuit, rather than as separate portions. In still further embodiments of the invention, the optional switching module 340 will be omitted, or will be configured in the opposite sense such that, e.g., rather than the bypass mode being configured as normally open as shown 342, it is configured as normally closed so as to allow operation of the EVSE system if the pilot interceptor module 300 is not operational.

In certain embodiments of the invention, the signal processing subsystem 334 will receive 344 a pulse width modulated input signal from the EVSE 346, and deliver 348 a corresponding pulse width modulated signal to the microcontroller 302. Similarly, the microcontroller 302 will produce a desirable pulse width modulated signal and deliver 350 that signal to the signal processing subsystem 334 which will, in turn, produce a pulse width modulated output signal at its output and deliver 352 that signal to the EVSE 346.

In an alternative embodiment of the invention, and/or in a different mode of operation, the signal processing subsystem 334 will receive 344 a pulse width modulated input signal from the EVSE 346, and deliver 348 a digital/numerical signal to the microcontroller 302. Similarly, the microcontroller 302 will produce a desirable digital/numerical signal and deliver 350 that signal to the signal processing subsystem 334 which will, in turn, produce a pulse width modulated output signal at its output and deliver 352 that signal to the EVSE 346.

In still further embodiments of the invention, the voltage level of the signals received 344 and dispatched 352 to the EVSE 346 are controlled by the signal processing subsystem 334.

As will be appreciated in light of the entirety of the present disclosure, input signal 344 and output signal 352 may be substantially similar to one another, or may be different, responsive to operation of the microcontroller 302 under principles of the present invention. In other embodiments and/or modes of operation, the microcontroller 302 will control operation of switching module 340 to simply pass the pilot signal produced by the EVSE through the pilot interceptor module 300 without substantial modification.

FIG. 3B shows a pilot interceptor module 354 generally similar to pilot interceptor module 300 of FIG. 3A. As illustrated, pilot interceptor module 354 includes a screw terminal assembly including a first screw terminal 356 and a second screw terminal 358. Screw terminals 356 and 358 are adapted to receive respective conductors of a pilot interceptor cable (like pilot interceptor cable 244 above) and operatively and substantially permanently fix those conductors to the pilot interceptor module 354.

Referring again to FIG. 3A, it will be appreciated by one of skill in the art that, during operation, the integrated microcontroller 302 will include dedicated control software adapted to control operation of the microcontroller 302, and the pilot interceptor module 300 as a whole. As further discussed herewith, the dedicated control software will be embodied in a physical configuration of hardware states within a memory storage portion of the microcontroller 302 and will be configured to include structure specifically adapted to optimization and improvement of microcontroller operation.

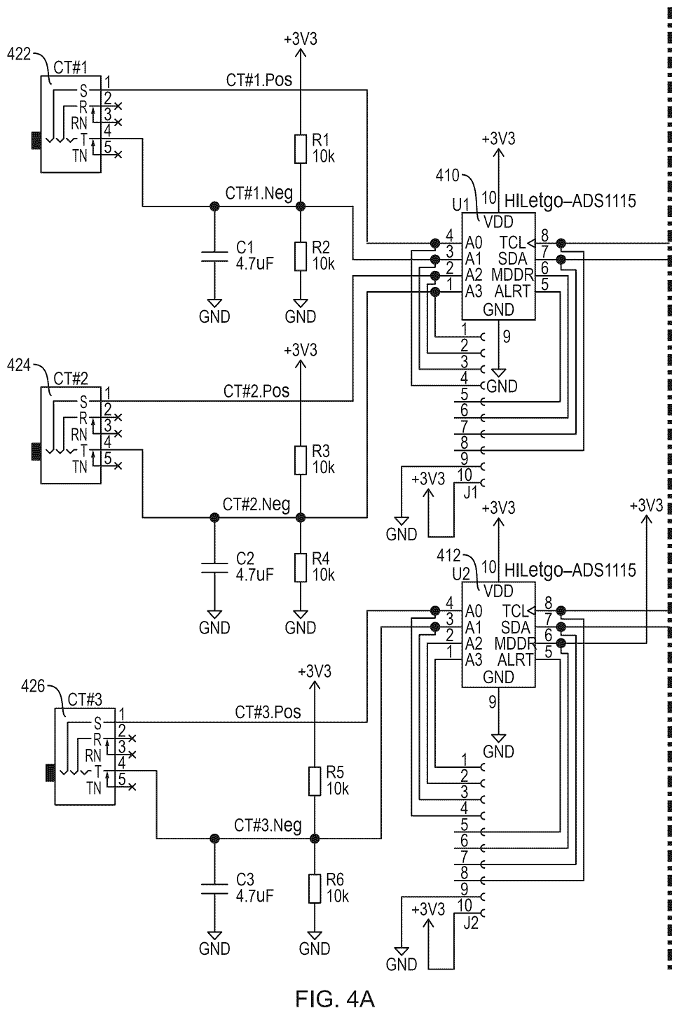

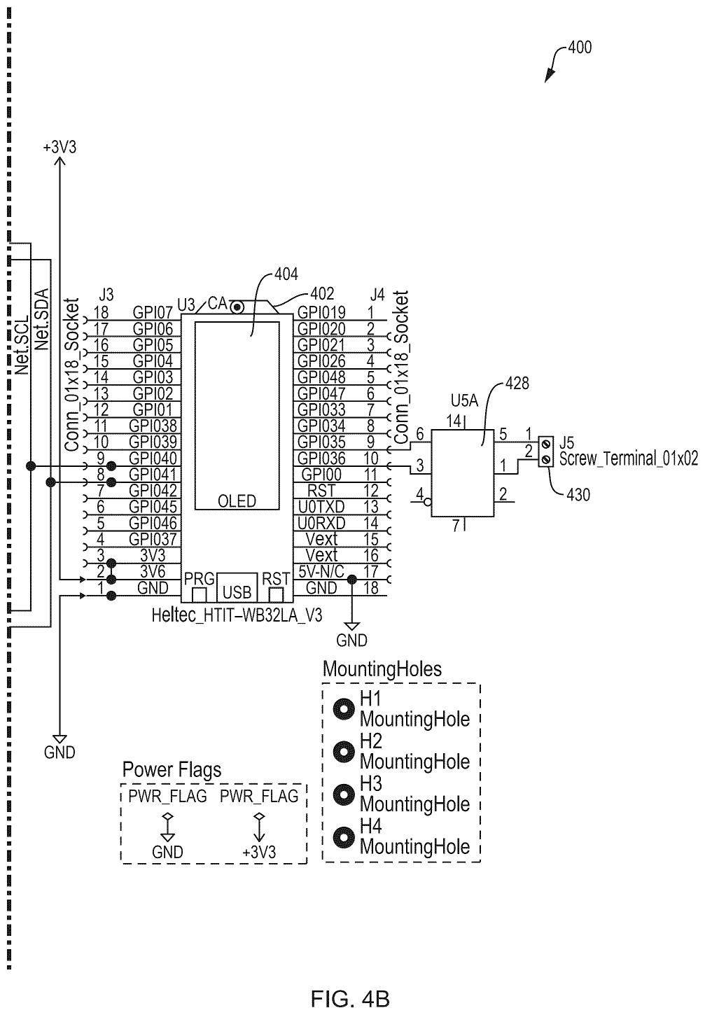

FIG. 4 shows, in electrical schematic diagram form, portions of an exemplary embodiment of a pilot interceptor module 400 prepared according to principles of the invention. With reference to the block diagrams of FIGS. 3A and 3B, pilot interceptor module 400 includes an exemplary integrated control unit including a microcontroller 402 and an integrated display 404. Also included in microcontroller 402 is an integrated LoRa wireless communication subsystem providing a bidirectional wireless network connection to the microcontroller 402.

In the illustrated example of a system according to the invention, first 410 and second 412 analog-to-digital converters are provided to receive, for example, analog feedback signals from respective current transformers and provide corresponding digital signals to the microcontroller 402.

One of skill in the art will appreciate that one or more current transformers will, in certain embodiments of the invention, be signalingly coupled to respective input and/or output power conductors in the manner of, e.g., current transformers 250 and 254 above. As discussed above, current transformers are merely representative examples of any appropriate sensor such as, for example, a Hall effect sensor, or other sensor beneficially applied in a corresponding embodiment of the invention.

The one or more current transformers are coupled to the analog-to-digital converters 410, 412 through respective 3.5 millimeter minijack sets 422, 424, 426. One of skill in the art will understand that a wide variety of other coupling mechanisms will be used in corresponding alternative embodiments of the invention.

The exemplary Pilot interceptor module 400 of FIG. 4 is implemented with a pilot signal processing device or subsystem 428. In certain embodiments of the invention, operation of the pilot signal processing device or subsystem 428 will correspond to the signal processing subsystem 334 described above. As illustrated, input and output signals of the pilot signal processing device or subsystem 428 are received through conductors substantially permanently coupled to screw terminals 430.

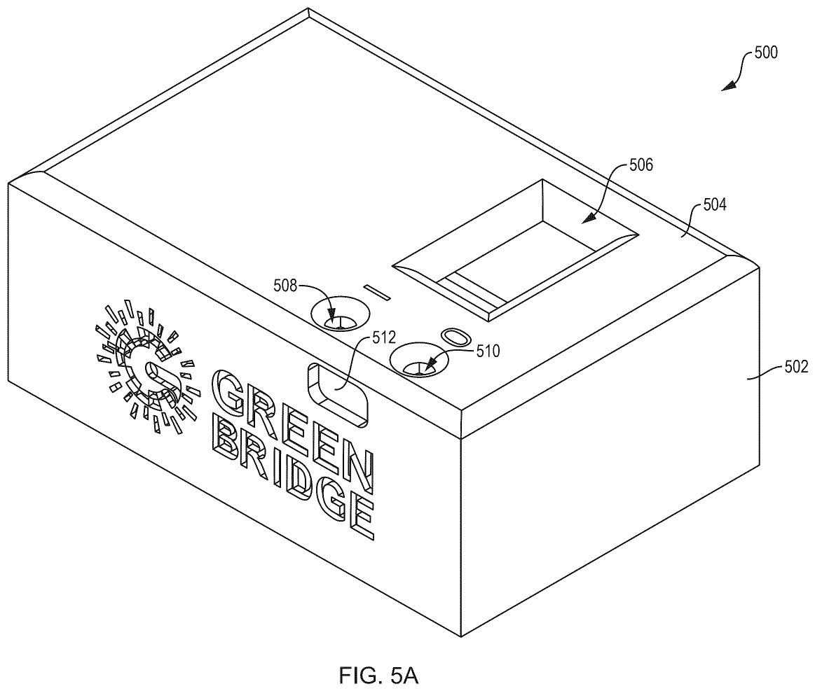

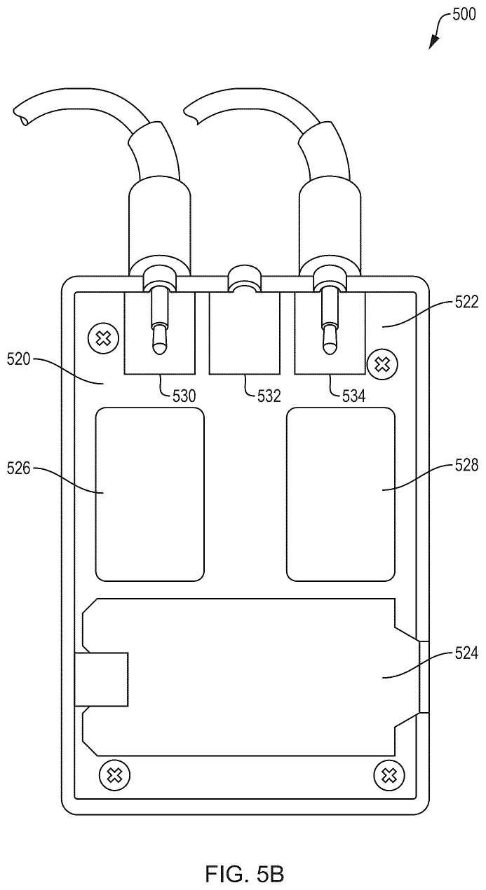

FIG. 5A shows, in schematic perspective view, an exemplary housing 500 for a pilot interceptor module prepared according to principles of the invention. As noted herewith, typical side dimensions for the housing 500 are selected to allow insertion of the housing 500 within an existing EVSE installation. Housing 500 includes a body 502 defining an internal recess or cavity adapted to receive a battery and a pilot interceptor control circuit therewithin. A cover 504 serves to enclose the internal cavity. In certain embodiments of the invention, the cover 504 includes an aperture 506 providing visual access to an integrated display of the pilot interceptor control circuit.

In certain embodiments of the invention, further apertures 508, 510 are provided in the cover 504. Apertures 508 and 510 are adapted to receive control buttons for manually starting and stopping operation of the pilot interceptor. An additional aperture 512 in the body of the housing 500 allows for passage of pilot interceptor signal wires into and out of the housing.

FIG. 5B shows, in schematic perspective view, further aspects of an exemplary housing 500 of the pilot interceptor, including a control circuit 520 disposed within an internal cavity 522 of the housing 500. With reference to FIGS. 3A and 3A above, the control circuit 520 includes a microcontroller module 524 and first 526 and second 528 analog to digital conversion devices. The control circuit 520 also supports first, second, and third minijack sets 530, 532 and 534 respectively.

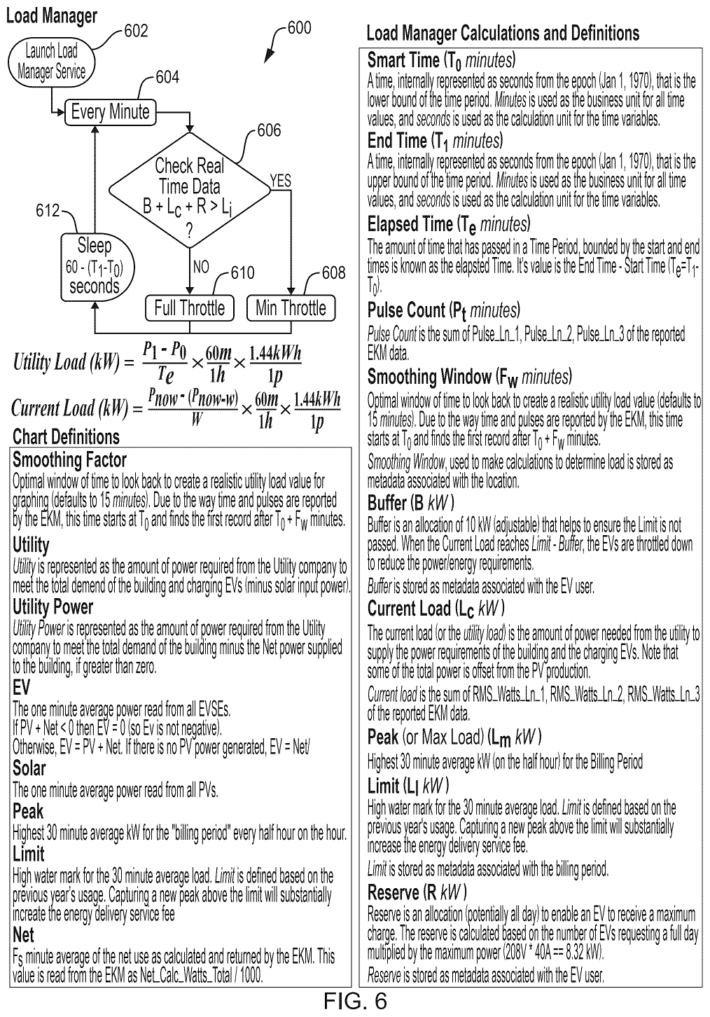

FIG. 6 shows, in schematic flowchart form, certain aspects and methods of operation of a pilot interceptor prepared according to principles of the invention, along with related operative definitions. Specifically, FIG. 6 shows a flowchart for a load manager service 600.

As indicated, upon launch 602, load manager service 600 is configured to cycle every minute 604. During each cycle, real-time data is received, establishing the current state of the input pilot signal received from an EVSE. Specifically, a limit Li is defined as a high watermark for 30 minute average load. This limit is defined based on the previous year's usage, and capturing a peak above the limit will substantially increase the energy delivery service fee.

The pilot interceptor captures values for Buffer B, Current Load Lc, and Reserve R. Buffer is an allocation of 10 Kilowatts (adjustable) that helps ensure the limit is not passed. When the current load reaches Limit minus Buffer, charging of the EV's is throttled down to reduce the power/energy requirements. Current Load Lc (or the utility load) is the amount of power needed from the utility to supply the power requirements of the building and the charging EVs. Note that some of the total power is offset from photovoltaic (PV) production. Reserve R is an allocation (potentially all day) to enable and EV to receive a maximum charge. The reserve is calculated based on the number of EVs requesting a full day multiplied by the maximum power (208V*40 A==8.32 KW).

Accordingly, for each 60 second cycle, the load manager service 600 compares 606 the limit Li to the sum of the Buffer B, Load Current Lc and Reserve R values. If limit Li is exceeded charging is reduced 608. Otherwise charging proceeds at full throttle 610.

Once the control calculation has been performed and appropriate action taken, the process sleeps 612 until the next cycle is due.

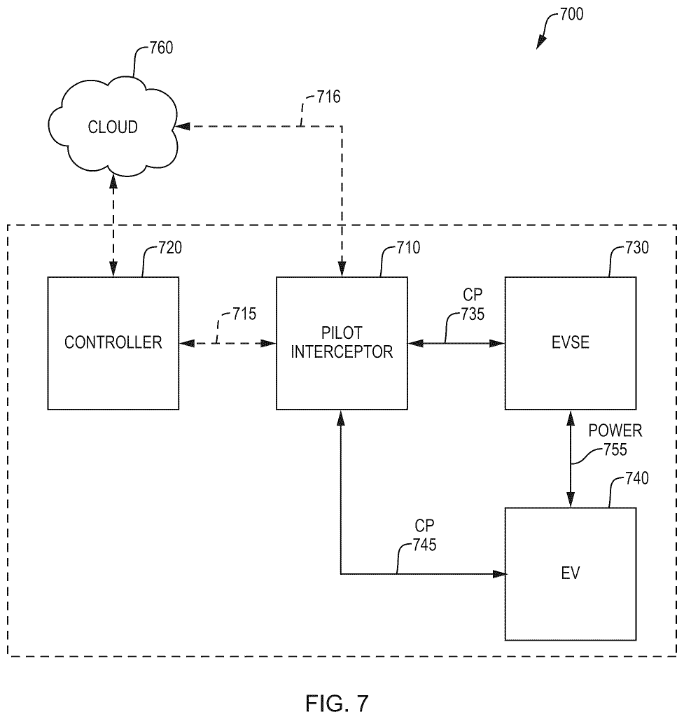

FIG. 7 shows, in schematic block diagram form, certain further aspects and major components in the EV charging environment 700 according to principles of the invention. A Pilot Interceptor 710 participates in bi-directional communication 715 with either a controller 720 or directly 716 with the Cloud 760, ultimately determining the rate of charge/discharge required to meet the control strategy. It leverages information collected from the EVSE 730, EV 740, and other data stored in the Cloud 760. A Pilot Interceptor 710 can make informed decisions regarding the charging and discharging of the EV's 740 battery and communicate those decisions through the control pilot signal 745 or pass through the unchanged signal 735 originating from the EVSE 730 to power 755 the EV 740.

In certain aspects and embodiments of the invention, the Pilot Interceptor 710 includes an edge device installed inside an electric vehicle supply equipment (EVSE—730) for the purpose of remotely controlling the EVSE's 730 outgoing analog or digital Control Pilot signal 735 as well as reading signals 745 from a connected EV 740 and transmitting 715 the data. An exemplary Pilot Interceptor includes a remote-controlled 720 data receptor, transmitter, and switch that both allows the existing Control Pilot signal to pass through unaltered 735, 745 and can also emulate/produce a Control Pilot signal with different instructions 745. Certain exemplary Pilot Interceptor apparatus can be retrofitted into any EVSE.

During operation of an exemplary Pilot Interceptor, an EVSE's analog Control Pilot signal is generated by the EVSE to detect the presence of the electric vehicle, to communicate the maximum allowable charging current 755, and to control charging session begin/end; the electric vehicle decides how much of the EVSE's available peak output capacity the EV can pull based on the vehicle battery's current operating parameters at that moment (e.g. state of charge, temperature, etc.).

There are also digital-based communication protocols for exchanging data between the EV and EVSE that also utilize the same electrical conductor as the analog Control Pilot signal. An exemplary Pilot Interceptor 710 can read and write data 735, 745 using these additional digital-based protocols.

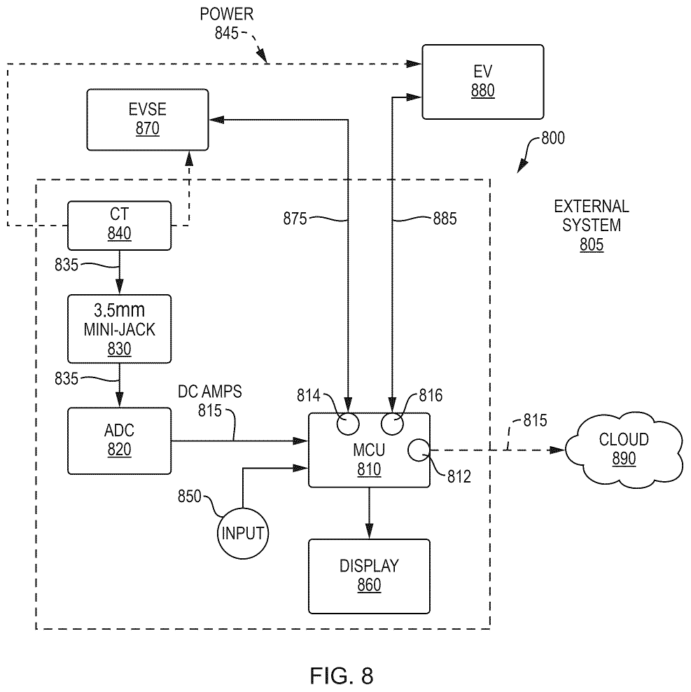

FIG. 8 shows, in schematic block diagram form, certain aspects and features, including exemplary internal components, of a Pilot Interceptor 800 and its interaction with an external system 805. Power 845 flows from the EV 880 through the Current Transformer 840 into the EVSE 870. This produces an analog output signal 835 of the current transformer that is passed via 3.5 mm mini-jack 830 and converted to digital form 815 by the ADC 820. That power information is used in a Microcontroller Unit (MCU) 810 in coordination with other data residing in the cloud 890 to intelligently power the charging and discharging of EVs 880. User interaction with the Pilot Interceptor 800 is possible through connected inputs 850 and the attached display device 860.

In certain embodiments, the Pilot Interceptor 800 includes an MCU hybrid module 810 outfitted with, a) a remote-controlled data receiver/transmitter 812, b) a terminal connection point 814 to read/write the EVSE's 870 incoming/outgoing data communication, and c) a terminal connection point 816 to read/write the EV's 880 outgoing data communication. During regular operation of an EVSE 870, the EVSE's pilot signal 875 passes unaltered through the Pilot Interceptor. Data communications 885 originating from the EV 880 also pass unaltered through the Pilot Interceptor, but data contents 815 are read and transmitted wirelessly to the cloud 890. Then, when activated by a separate control system 720 (FIG. 7), this edge device produces a new pilot signal 885 that travels over the wire and into a connected EV 880. For example, the Pilot Interceptor 810 can change an EVSE's 870 pilot signal 875 to change the maximum rate of charge that the connected EV 880 will pull 845.

In another exemplary embodiment, the Pilot Interceptor can change an EV's 880 signal 885 to discharge 845 its battery as in both vehicle-to-grid (V2G) and Vehicle Grid Integration (VGI) scenarios.

The EVSE's analog Control Pilot signal is generated by the EVSE to detect the presence of the electric vehicle, to communicate the maximum allowable charging current, and to control charging session begin/end; the electric vehicle then uses that information to decide how much of the EVSE's available peak output capacity the EV can pull based on the vehicle battery's current operating parameters at that moment (e.g. state of charge, temperature, etc.)

There are also digital-based communication protocols for exchanging data between the EV and EVSE that also utilize the same electrical conductor as the analog Control Pilot signal. According to certain embodiments of the invention, the Pilot Interceptor can read and write data using these additional digital-based protocols.

Managing EVSE charge and discharge rates is very important to the operation of an EVSE. For example, intelligently managing an EVSE's charge rate can prevent expensive utility grid demand charges. Also, intelligently managing an EVSE's discharge rate to send energy bidirectionally back to the grid can provide the electric grid with valuable ancillary services.

EVSEs are typically operated via proprietary—and unregulated—software/firmware that doesn't allow for charge limits to be dynamically implemented. There is no standardized way to manage EVSE charge/discharge limits.

Also, EVSEs are typically operated via proprietary—and unregulated—software/firmware that doesn't allow for the EVSE to interface with ISO/RTO grid signals to manage charge/discharge limits and signal latency for V2G-enabled ancillary services and demand response.

All of these problems are being compounded as more makes/models of EVSEs are deployed into operation on the grid (to charge electric vehicles) that run disparate controlling software/firmware programs.

Accordingly, in its various aspects and embodiments, the Pilot Interceptor solves the above-described problems by bypassing the multitude of existing software/firmware version(s) to create a common means of manipulating an EVSE's pilot signal in a remote-controlled, dynamic, and nearly instantaneous way. The Pilot Interceptor democratizes the control of disparate EVSEs to help EVSE operators avoid high demand charges and prevent grid instability and respond more quickly to ISO/RTO grid signals. The Pilot Interceptor can provide EVSE operators with a common, direct, remote-controlled way to manage their owned infrastructure.

The Pilot Interceptor improves EVSE operation for EVSE operators—most of whom have purchased and own EVSEs, but who cannot control them in a common way—by allowing operators to, a) change EVSE charge rate (i.e., power to EV), b) change the EVSE discharge rate (i.e., power back to grid), c) start/stop EVSE charging sessions, d) start/stop EVSE discharging. All of these functions offer significant opportunity for EVSE operators to control energy costs and maximize revenue through utility grid services.

In its various aspects and embodiments, the Pilot Interceptor, a) allows for faster EVSE control, b) de-risks EVSE control by eliminating/bypassing extra software/firmware layers, c) is a more robust way to manipulate EVSE charge and discharge rates of EV batteries, and d) allows for ISO grid signals to control the EVSE.

In certain embodiments, the Pilot Interceptor is a device that is hardwired inside the EVSE enclosure, intercepting the Pilot Signal before it travels out of the EVSE through the cable that is connected to the EV. This marks an improvement over any system including two “couplers” that attach on one side to the EVSE and on the other to the EV. The Pilot Interceptor only interacts with the electrical conductor associated with the Pilot Signal. Finally, the Pilot Interceptor is able to read and write data using both analog and digital protocols.

The Pilot Interceptor offers the benefits of being simple, small and inexpensive, while enabling remote control of the EV charge/discharge behavior. The Pilot Interceptor is invisible to EV drivers and is thus unsusceptible to tampering or theft. Additionally, since high/dangerous charge/discharge power does not travel through the device, an exemplary Pilot Interceptor requires no consumer safety protocols or certifications to operate legally and safely inside an EVSE. Finally, since the Pilot Interceptor does not interact with any high-power conductors within an EVSE, the Pilot Interceptor can easily be implemented into EVSEs with different EVSE ports/connectors/cables that charge/discharge vehicles using AC or DC power, such as CCS, CHAdeMO, NACS or J1772 EVSE ports.

In certain embodiments of the invention a method of controlling an electric vehicle service equipment (EVSE) will include providing an EVSE which includes a housing, a control circuit disposed within the housing, a coupler, and a charging cable. The charging cable is operatively coupled between the control circuit and the coupler. The charging cable will include at least a first power conductor and a second signal conductor, where the second signal conductor is adapted to communicate a pilot signal between a vehicle to be charged and the control circuit.

A pilot interceptor module is provided, the pilot interceptor module including an electronic device for producing a desired substitute pilot signal on the second signal conductor. The pilot interceptor module will be disposed within the housing, substantially permanently coupled signalingly in series with the signal conductor between the coupler and the EVSE and will operate the pilot interceptor module to produce the substitute pilot signal.

In certain embodiments of the invention a method of controlling an electric vehicle service equipment (EVSE) the electronic device comprises a microcontroller unit.

In certain embodiments of the invention a method of controlling an electric vehicle service equipment (EVSE) will include severing the signal conductor between the coupler and the control circuit to produce a first severed end and a second severed end, substantially permanently coupling the first severed end to a first pilot terminal of the pilot interceptor module and substantially permanently coupling the second severed end to a second pilot terminal of the pilot interceptor module.

In certain embodiments of the invention a method of controlling an electric vehicle service equipment (EVSE) will comprise receiving a signal from an external network and operating the electronic device to determine a characteristic of the substitute pilot signal so as to manage a load characteristic of said EVSE.

In certain embodiments of the invention a method of controlling an electric vehicle service equipment (EVSE) the external network comprises a cloud network, while in other embodiments the external network comprises the Internet.

Additional embodiments and implementations of the invention, as follows, are intended to be within the scope of the invention as presently described:
1. A revenue-grade meter can be included to provide ‘proof’/data to third party stakeholders—such as utilities, commercial partners, etc.—about EVSE operations governed by the Pilot Interceptor, such as charge/discharge rates, kWh throughput, utilization, grid/market signals, etc. Why would a revenue-grade meter be helpful for Pilot Interceptor operation by an EVSE owner? Examples:
   The meter can prove that a certain amount of vehicle-to-grid kWh energy was dispensed from an EV's battery, thus a specific amount of revenue is owed to an EVSE owner from a utility.
   The meter can prove to a building owner that an EVSE's charging capacity (kW) was ramped down during a peak load period.
   The meter can prove to a utility that a certain kW amount of demand response happened at a specific time of day.
2. The Pilot Interceptor can function in a “first responder” role when it comes to environmental safety factors, such as fire, high winds, etc.
3. The Pilot Interceptor can act on news of a scheduled power outage and gracefully power down existing charging sessions, prevent new sessions during the brownout/blackout period, and power down the EVSE to prevent damage from a sudden power loss.
4. In coordination with Solar and Battery charging systems, the Pilot Interceptor can facilitate optimized charging/discharging cycles through use of Al learning methods. For example, based on learned patterns, one EV may participate in powering other EVs.
5. The Pilot Interceptor can work in a mesh-networked environment of other Pilot Interceptors, intelligently controlling charging/discharging when the utility power is not available but there is solar or battery storage to utilize. The battery backup on an exemplary Pilot Interceptor device is capable of standalone operation for days of use.
6. The Pilot Interceptor can be used on non-EV devices to monitor power consumption and use that information to assist load balancing for additional prioritization approaches.
7. The Pilot Interceptor can participate in improving the power factor to provide more efficient use of the available power.
8. The Pilot Interceptor can identify and help solve line-load balancing in a 3-phase environment, improving power factor and making more energy available.
9. A Pilot Interceptor prepared according to principles of the invention can take taking control over chargers whose previous EV charging network has stopped communicating with the EVSE or the EVSE's manufacturer has stopped supporting the EVSE. (e.g. If the EV network provider or the EVSE manufacturer goes out of business.) The Pilot Interceptor (PI) is a way to take control or and manage orphaned or abandoned EVSEs.

While the exemplary embodiments described above have been chosen primarily from the field of electric vehicle supply and charging for personal and fleet electric vehicles, one of skill in the art will appreciate that the principles of the invention are equally well applied, and that the benefits of the present invention are equally well realized in a wide variety of other power and transportation systems. Further, while the invention has been described in detail in connection with the presently preferred embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Accordingly, the invention is not to be seen as limited by the foregoing description, but is only limited by the scope of the appended claims.

1. A method of controlling an electric vehicle service equipment (EVSE) comprising:
providing said EVSE, said EVSE including a housing, a control circuit disposed within said housing, a coupler, and a charging cable, said charging cable being operatively coupled between said control circuit and said coupler, said charging cable including at least a first power conductor and a second signal conductor, wherein said second signal conductor is adapted to communicate a pilot signal between a vehicle to be charged and said control circuit;
providing a pilot interceptor module, said pilot interceptor module including an electronic device for producing a desired substitute pilot signal on said second signal conductor;
disposing said pilot interceptor module within said housing;
substantially permanently coupling said pilot interceptor module signalingly in series with said signal conductor between said coupler and said EVSE; and
operating said pilot interceptor module to produce said substitute pilot signal.

2. A method of controlling an electric vehicle service equipment (EVSE) as defined in claim 1, wherein said electronic device comprises a microcontroller unit.

3. A method of controlling an electric vehicle service equipment (EVSE) as defined in claim 1 further comprising:
severing said signal conductor between said coupler and said control circuit to produce a first severed end and a second severed end;
substantially permanently coupling said first severed end to a first pilot terminal of said pilot interceptor module; and
substantially permanently coupling said second severed end to a second pilot terminal of said pilot interceptor module.

4. A method of controlling an electric vehicle service equipment (EVSE) as defined in claim 3 wherein said substantially permanently coupling said first severed end to a first pilot terminal of said pilot interceptor module comprises mechanically crimping said first severed end to a conductor of a pilot interceptor cable.

5. A method of controlling an electric vehicle service equipment (EVSE) as defined in claim 1 further comprising:
receiving a signal from an external network;
operating said electronic device to determine a characteristic of said substitute pilot signal so as to manage a load characteristic of said EVSE.

6. A method of controlling an electric vehicle service equipment (EVSE) as defined in claim 5 wherein said external network comprises a cloud network.

7. A method of controlling an electric vehicle service equipment (EVSE) as defined in claim 5 wherein said external network comprises the Internet.
